(19) United States
(12) Patent Application Publication
(10) Pub. No.: US 2026/0269612 A1
(43) Pub. Date: Sep. 10, 2026

(54) LOAD EMERGENCY CONTROL METHOD BASED ON DYNAMIC EVENT TRIGGER MECHANISM

(71) Applicant: NANJING UNIVERSITY OF POSTS AND TELECOMMUNICATIONS, Nanjing (CN)

(72) Inventors: Tengfei ZHANG, Nanjing (CN); Hualei ZOU, Nanjing (CN); Yu CHEN, Nanjing (CN); Yiling CHENG, Nanjing (CN); Xia ZHOU, Nanjing (CN); Yang YANG, Nanjing (CN); Yang YU, Nanjing (CN); Minghao FAN, Nanjing (CN)

(73) Assignee: NANJING UNIVERSITY OF POSTS AND TELECOMMUNICATIONS, Nanjing (CN)

(21) Appl. No.: 19/660,701

(22) Filed: Apr. 28, 2026

Related U.S. Application Data
(63) Continuation of application No. PCT/CN2025/111551, filed on Jul. 30, 2025.

(30) Foreign Application Priority Data
Aug. 15, 2024 (CN) 202411117937.7

(51) Int. Cl. H02J 3/001; G06Q 50/06; H02J 3/17; H02J 3/28; H02J 3/38; H02J 13/16; H02J 101/20

(52) U.S. Cl. CPC H02J 3/001; G06Q 50/06; H02J 3/17; H02J 3/28; H02J 3/38; H02J 13/16; H02J 2101/20

(57) ABSTRACT

Provided is a load emergency control method based on a dynamic event trigger mechanism, belonging to the field of smart grid and power system automation control. The method performs regional division on a distribution network according to a safe operation index of a system; proposes an adaptive load level division method based on user response willingness, and establishes an accurate load control model of the distribution network by taking a minimum operation cost of a system of the distribution network as the goal; and uses a dynamic event trigger mechanism to reduce communication between a substation and a master station of the distribution network, and to achieve effective interaction and accurate execution of load control strategy information. The method can achieve accurate load control, effectively alleviate a communication transmission pressure of the distribution network, and ensure stability of a power grid and continuous supply of a key load.

### CROSS-REFERENCE TO RELATED APPLICATION

This application is a continuation of International Application No. PCT/CN2025/111551, filed on Jul. 30, 2025, which claims priority to Chinese Patent Application No. 202411117937.7, filed on Aug. 15, 2024. The disclosures of the above-mentioned applications are hereby incorporated by reference in their entireties.

### TECHNICAL FIELD

The present disclosure belongs to the field of smart grid and power system automation control, and in particular, to a load emergency control method based on a dynamic event trigger mechanism.

### BACKGROUND

Rapid growth of power demands puts forward severe requirements for power supply. When there is power shortage in a distribution network line, it is necessary to dispatch a master station to make a decision to curtail part of loads quickly, thereby stabilizing steady-state power shortage of a power grid, and improving safety, resilience, and adjustment flexibility of the power grid. A conventional low-frequency decrease load control method achieves balance between power supply and power demand by curtailing an entire transmission line in a distribution network region, thereby leading to an increase in an operation risk of the distribution network, and having a negative impact on normal economic development of society and living standards of users. Therefore, it is necessary to study a load curtailment in a low-accident level scenario, and how to tap the potential of the load curtailment on a distribution network side and implement the load curtailment operation accurately and quickly is an urgent problem to be solved at present.

The current distribution network fails to fully exploit flexibility resources at a user side and a user response degree under the guidance of time-of-use electricity price when performing the load curtailment accurately. In addition, although a static event trigger mechanism can alleviate a communication pressure of the distribution network to a certain extent, the dynamic trigger mechanism has been proved to be able to achieve information transmission according to less data sampling or data transmission in a complex transmission system, thereby reducing the communication pressure. However, for the load curtailment operation of the distribution network, how to arrange an appropriate dynamic event trigger mechanism to reduce the communication pressure between a master station and a substation of the distribution network remains to be studied.

### SUMMARY

In order to solve the above technical problems, the present disclosure provides a load emergency control method based on a dynamic event trigger mechanism. In an emergency, a demand side, and especially residential load willingness and effective communication conditions, are fully considered. A power grid safety and stability control system can accurately curtail the power grid load according to an issued load curtailment strategy through power grid risk assessment and load priority division, thereby ensuring stability of the power grid and supply of a key load.

The present disclosure provides a load emergency control method based on a dynamic event trigger mechanism, including the following steps:
Step 1, performing regional division on a distribution network according to a safe operation index of a system to ensure a safe operation condition of the system;
Step 2, based on the divided region, proposing an adaptive load curtailment adjustment range method based on a real-time electricity price, and establishing a user participation load curtailment response coefficient based on the real-time electricity price;
Step 3, establishing an accurate load control model of the distribution network in each region by taking a minimum operation cost of a substation of the distribution network as the goal;
Step 4, using a dynamic event trigger mechanism, achieving effective interaction and accurate execution of load curtailment strategy information in this region and load control strategy information in neighboring regions;
Step 5, according to an electricity price signal, fully considering willingness of a user side of the load curtailment in this region to participate in the load curtailment, and based on the accurate load control model of the distribution network, taking a minimum operation cost of the distribution network as the goal and taking safe operation of the system as a constraint condition, using an alternating direction method of multipliers to calculate an optimal load curtailment strategy of each region; and
Step 6, based on the optimal load curtailment strategy obtained in Step 5, when there is power shortage in the distribution network, using an interruptible load participating in a load curtailment operation in this region to adjust safe and stable operation of the system.

Further, in Step 1, regional division is performed on the distribution network on the basis of considering stability characteristics of the power grid, that is, voltage regulation ability is fully considered on the basis of considering a modularity index to achieve optimal division of the distribution network;
the modularity index of the distribution network is used to measure a correlation degree between two nodes in a distribution network region, which is specifically as follows:

$${ρ}_{l} = \frac{1}{2 m} {\sum }_{i} {\sum }_{j} ( {l}_{ij} - \frac{{k}_{i} {k}_{j}}{2 m} ) δ ( i , j ) \qquad ( 1 )$$

where ρᵢ denotes a correlation degree between nodes, Iᵢⱼ denotes an electrical distance between node i and node j, i and j denotes nodes in the distribution network, kᵢ denotes a node degree of the node i, and kᵢ=ΣᵢIᵢⱼ denotes the sum of the weights of all edges connected with the node i; kⱼ denotes a node degree of the node j; m denotes the sum of weights of all edges in the divided region, that is,

$$m = ( {\sum }_{i} {\sum }_{j} {l}_{ij} ) / 2 ;$$

and δ(i,j) denotes a binary variable, and when δ(i,j)=1, it indicates that the nodes i and j are located in the same region, otherwise, δ(i,j)=0;
an index of the correlation degree between two nodes in the distribution network is as follows:

$${l}_{ij} = \sqrt{{\sum }_{i = 1}^{w} {( {D}_{iw} - {D}_{jw} )}^{2}} \qquad ( 2 )$$

$${D}_{ij} = lg \frac{{S}_{VP , jj} + {S}_{VQ , jj}}{{S}_{VP , ij} + {S}_{VQ , ij}} \qquad ( 3 )$$

where values of i and j range from 1 to w, i≠j; S_{VP,jj} denotes voltage sensitivity of a load node j to active power supply j, S_{VQ,jj} denotes voltage sensitivity of the load node j to reactive power supply j, S_{VP,ij} denote voltage sensitivity of a load node i to the active power supply j, and S_{VQ,ij} denote voltage sensitivity of the load node i to the reactive power supply j; D_{iw} is used to measure an influence of a node w on the node i, D_{jw} is used to measure an influence of the node w on the node j, Dᵢⱼ denotes a comprehensive influence of power change of the node j on the node i, the smaller Dᵢⱼ is, the greater the influence of power change of the node j on the node i is, and the smaller the distance between the two nodes is; and the greater the value of ρₜ is, the better the division structure of the distribution network is; and
considering the voltage regulation ability, a voltage regulation index is introduced to perform regional division, which is specifically as follows:

$${ρ}_{V} = \frac{1}{N} {\sum }_{n ∈ N} ( {\sum }_{t} {φ}_{V}^{n , t} ) \qquad ( 4 )$$

where ρᵥ denotes an average value of voltage deviations in each region;

$${φ}_{v}^{n , t}$$

denotes a voltage measurement index of each node i in the region n at time t; and when a maximum value of voltage deviations ΔVᵢ in the region is less than a maximum value of allowable deviations ΔV_{i,max} in the region,

$${φ}_{v}^{n , t} = 1 ,$$

otherwise the value is ΔVᵢ/ΔV_{i,max}, and N denotes the number of divided in the region, regions.

Further, in Step 2, assuming that a user expected value of the electricity price at time t is p_{ex,t}, when an actual electricity price is higher than the user expected value, user participation is high, and an adjustable load quantity increases at this time; and on the contrary, user willingness decreases, a corresponding load curtailment decreases, and therefore, a user response coefficient is established:

$${ρ}_{i , t} = {ξ}_{i} ( {e}^{\frac{{p}_{t}}{{p}_{max}} - 1} - {e}^{\frac{{p}_{ex , t}}{{p}_{max}} - 1} ) \qquad ( 5 )$$

where ρ_{i,t} denotes a response coefficient of a user at the node i participating in the distribution network at time t, pₜ denotes an actual electricity price at time t, pₘₐₓ denotes a maximum value of the electricity price, and ξᵢ denotes participation willingness of the user at the node i, ξᵢ≥0;
when ρ_{i,t}>0, the user at the node i actively participates at time t, an upward margin of the load curtailment at the node increases, and a corresponding interruptible power adjustment range increases accordingly; on the contrary, a downward margin of the load curtailment decreases, and the interruptible power adjustment range decreases accordingly; and therefore, a change value

$$Δ {P}_{l , i , t}^{curt}$$

reflecting the load curtailment is defined as:

$$Δ {P}_{l , i , t}^{curt} = {ρ}_{i , t} ( {P}_{l , i , t}^{ori , max} - {P}_{l , i , t}^{ori , min} ) \qquad ( 6 )$$

when

$$Δ {P}_{l , i , t}^{curt} > 0 ,$$

the user actively participates, and when

$$Δ {P}_{l , i , t}^{curt} < 0 ,$$

the electricity price is lower than the user expected value, and the user participation decreases accordingly; and therefore, an upper limit and a lower limit of the load curtailment are adjusted adaptively through the electricity price signal based on original values, that is:

$$when Δ {P}_{l , i , t}^{curt} \geq 0 :$$

$${P}_{l , i , t}^{up} = min ( Δ {P}_{l , i , t}^{curt} + {P}_{l , i , t}^{ori , max} , {P}_{l , i , t}^{ori , max} , {P}_{l , i , t} ) , and \qquad ( 7 )$$

$$when Δ {P}_{l , i , t}^{curt} < 0 :$$

$${P}_{l , i , t}^{down} = max ( {P}_{l , i , t}^{ori , min} - Δ {P}_{l , i , t}^{curt} , {P}_{l , i , t}^{ori , min} ) \qquad ( 8 )$$

the adjusted upper limit of the load curtailment does not exceed a total load value of the current user,
where

$${P}_{l , i , t}^{ori , max} and {P}_{l , i , t}^{ori , min}$$

denote original upper and lower limits of a load curtailment power, and

$${P}_{l , i , t}^{up} and {P}_{l , i , t}^{down}$$

denote changed upper and lower limits of the user load curtailment quantity under the guidance of the electricity price.

Further, a cost paid by the distribution network to the user is modeled as follows:

$$min {C}_{t}^{user} = {\sum }_{m = 1}^{M} ( {λ}_{m} {P}_{m , t}^{curt} ) \qquad ( 9 )$$

where

$${C}_{t}^{user}$$

denotes a cost generated by the distribution network to compensate the user at time t, M denotes the number of interruptible load levels, and λₘ denotes a compensation price corresponding to an m-th interruptible load; if the load level is higher, the compensation that the user obtains is greater, that is, the value of the compensation price λₘ corresponding to a high load level is greater; and

$${P}_{m , t}^{curt}$$

denotes a total quantity of the m-th interruptible loads at time t;
a constraint of the interruptible load on a safety range of the load curtailment is:

$${b}_{i , t} {P}_{l , i , t}^{down} \leq {P}_{l , i , t}^{curt} \leq {b}_{i , t} {P}_{l , i , t}^{up} , {b}_{i , t} ∈ [ 0 , 1 ] \qquad ( 10 )$$

where

$${P}_{l , i , t}^{curt}$$

denotes a total quantity of all interruptible loads at the node i at time t;

$${P}_{l , i , t}^{curt} = {\sum }_{m = 1}^{M} {P}_{m , i , t}^{curt} \qquad ( 11 )$$

where

$${P}_{m , i , t}^{curt}$$

denotes the quantity of the m-th interruptible loads at the node i at time t;
a constraint on the maximum number of curtailing operations is:

$${\sum }_{t = 1}^{T} {b}_{i , t} , {b}_{i}^{max} \qquad ( 12 )$$

where

$${b}_{i}^{max}$$

denotes the maximum number of interruptions of the interruptible load; and
constraints on the minimum duration and the maximum duration of the load curtailment are:

$$\{ \begin{matrix}{\sum }_{t = 1}^{t + {T}_{m i n}^{curt} - 1} {b}_{i , t} \geq {T}_{m i n}^{curt} ( {b}_{i , t} - {b}_{i , t - 1} ) \\ {\sum }_{t = 1}^{t + {T}_{m ax}^{curt} - 1} ( 1 - {b}_{i , t} ) \geq 1\end{matrix} \qquad ( 13 )$$

where b_{i,t} denotes the state of the interruptible load at time t, and b_{i,t-1} denotes the state of the interruptible load at time t-1; when b_{i,t}=1, it indicates that the interruptible load participates in the load curtailment operation, otherwise the interruptible load does not participate in the load curtailment operation;

$${b}_{i}^{max}$$

denotes the maximum number of interruptions of the interruptible load; and

$${T}_{m ax}^{curt} and {T}_{m i n}^{curt}$$

denote the maximum interruption duration and the minimum interruption duration of the interruptible load.

Further, Step 3 specifically includes:

Step 3-1: performing load curtailment control on the distribution network and establishing an objective function:

$$f = min {{\sum }_{i = 1}}^{I} {\sum }_{t = 1}^{T} ( {C}_{i , t}^{grid} {P}_{i , t}^{grid} + {C}_{t}^{user} ) \qquad ( 14 )$$

where

$${P}_{i , t}^{grid}$$

denotes a power value of the node i trading with the main power grid at time t, and the value is positive when electricity is purchased from the main power grid and is negative when electricity is not purchased from the main power grid; and

$${C}_{i , t}^{grid}$$

denotes a cost coefficient of the node i trading with the main power grid at time t;
in order to ensure safe operation of the system, it is necessary to establish a constraint condition for the safe operation, where a linear power flow constraint is:

$$\{ \begin{matrix}{P}_{i , t}^{grid} + {P}_{i , t}^{D G} + {P}_{i , t}^{S} - {P}_{i , t}^{L o a d} - {P}_{l , i , t}^{curt} = {P}_{i , t} \\ {Q}_{i , t}^{grid} + {Q}_{i , t}^{D G} + {Q}_{i , t}^{S} - {Q}_{i , t}^{L o a d} - {Q}_{l , i , t}^{curt} = {Q}_{i , t}\end{matrix} \qquad ( 15 )$$

where

$${P}_{i , t}^{DS} and {P}_{i , t}^{S}$$

denote the active power of renewable energy outputting and energy storage charging and discharging at the node i at time t, respectively, and

$${Q}_{i , t}^{D S} and {Q}_{i , t}^{S}$$

denote the corresponding reactive power;
phase angle relaxation of branch power flow is performed in Formula (15), and the linear power flow constraint obtained after relaxation is as follows:

$$\{ \begin{matrix}{P}_{j} = {\sum }_{k ; j \to k} {P}_{jk} - {\sum }_{ii \to j} ( {P}_{ij} - {r}_{ij} {h}_{ij} ) , ∀ j ∈ N , ∀ t \\ {Q}_{j} = {\sum }_{k ; j \to k} {Q}_{jk} - {\sum }_{ii \to j} ( {Q}_{ij} - {x}_{ij} {h}_{ij} ) , ∀ j ∈ N , ∀ t\end{matrix} \qquad ( 16 )$$

an expression of the power at the head of the branch after relaxation is as follows:

$${P}_{ij}^{2} + {Q}_{ij}^{2} \leq {h}_{ij} {v}_{i} , ∀ t \qquad ( 17 )$$

Formula (17) is further rewritten as a form of rotated Second-Order Cone Programming (SOCP) as follows:

$${‖ \begin{matrix}2 {P}_{j} \\ 2 {Q}_{j} \\ {h}_{ij} - {v}_{i}\end{matrix} ‖}_{2} \leq {h}_{ij} + {v}_{i} , ∀ t \qquad ( 18 )$$

in order to ensure that the active power of a controllable unit in the distribution network operates within the allowable safety range, upper and lower operating limits are constrained as shown in Formula (19):

$${P}_{x , min} \leq {P}_{x} \leq {P}_{x , max} , ∀ t \qquad ( 19 )$$

similarly, in order to ensure that the reactive power of the controllable unit in the distribution network operates within the allowable safety range, the upper and lower operating limits are constrained as shown in Formula (20):

$${Q}_{x , min} \leq {Q}_{x} \leq {Q}_{x , max} , ∀ t \qquad ( 20 )$$

during the operation of the distribution network, a voltage of each node operates within the safety range, and therefore, a constraint condition of each node is as shown in Formula (21):

$${V}_{i , min} \leq {V}_{i} \leq {V}_{i , max} , ∀ t . \qquad ( 21 )$$

Further, Step 4 specifically includes:
assuming that an operation state value of the distribution network measured by an i-th measuring device at the k-th sampling time is x_{i,k}=[P_{load,t}, P_{ij,t}, v_{i,t}]^{T}, expressing an event generation function as:

$${l}_{i} ( {x}_{i , k} , {x}_{i , τ} ) = ‖ {x}_{i , k} - {x}_{i , τ} ‖ - {σ}_{i} ‖ {x}_{i , τ} ‖ \qquad ( 22 )$$

where x_{i,t} denotes a system operation state vector transmitted to a master station of the distribution network at the latest time; and σᵢ denotes a trigger threshold of the i-th measuring device;
based on Formula (22), constructing a generation function based on the dynamic event trigger mechanism as:

$$f ( {x}_{i , k} , {x}_{i , τ} ) = α l ( {x}_{i , k} , {x}_{i , k} ) - {δ}_{i , k} \qquad ( 23 )$$

where δ_{i,k} denotes a dynamic variable set in the dynamic event trigger mechanism, and the minimum sampling interval under the dynamic event trigger mechanism is not less than the minimum sampling interval under a static event trigger mechanism; and δ_{i,k+1}=λδ_{i,k}−Iᵢ(x_{i,k}, x_{i,t}), where λ is a scalar between (0, 1), and α≥1/λ; and
based on Formula (23), between intervals (t_{i,k}, t_{i,k+1}) of any two trigger moments, defining a logical trigger variable γ_{i,k} according to a calculated value of the event generation function, where the specific expression is:

$${γ}_{i , k} = \{ \begin{matrix}1 & f ( {x}_{i , k} , {x}_{i , τ} ) > 0 \\ 0 & f ( {x}_{i , k} , {x}_{i , τ} ) , , 0\end{matrix} \qquad ( 24 )$$

where according to Formula (24), when γ_{i,k} is 1, the substation updates its own controller, the master station transmits the state data of the substation to a neighboring substation of the distribution network at the same time, Iᵢ(x_{i,k}, x_{i,t}) is set to 0, the trigger function is ƒ( )<0, the logic variable γ_{i,k} is set to 0 at this time and is executed again until the next trigger function is met again, and when there is power shortage and other substations need to coordinate the load curtailment to ensure the stable operation of the system, the dynamic event trigger mechanism is implemented.

The method provided by the present disclosure has the following beneficial effects. Under a current dynamic electricity price mechanism, the method provided by the present disclosure guides a user to actively participate in the load curtailment operation of the distribution network by establishing a response coefficient. The mechanism not only helps to generate an adaptive load curtailment strategy, but also enables the user to obtain more compensation and reduces an operation cost of the master station of the distribution network. The present disclosure also improves information transmission efficiency between the master station and the substation of the distribution network by introducing a dynamic event trigger mechanism, thereby effectively reducing the communication burden in a power information transmission process.

### BRIEF DESCRIPTION OF THE DRAWINGS

FIG. 1 is a flowchart of a dynamic event trigger mechanism.

FIG. 2 is a frame diagram of a load curtailment control strategy.

FIG. 3 is a schematic diagram of an improved 33-node distribution network system.

FIG. 4 is a graph of photovoltaic power, a wind turbine output power load demand, and an electricity price.

FIG. 5 is a schematic diagram of a voltage level of a typical node.

FIG. 6 is a diagram of voltage levels of all nodes.

FIG. 7 is a schematic diagram of scheduling results of a conventional equal-proportion load curtailment.

FIG. 8 is a schematic diagram of scheduling results of an adaptive load curtailment.

FIG. 9 is a schematic diagram of a time trigger moment of each sub-region.

FIG. 10 is a flowchart of a method according to the present disclosure.

### DETAILED DESCRIPTION OF THE EMBODIMENTS

For a clearer understanding of the content of the present disclosure, the present disclosure will be described in further detail according to the specific embodiment and the drawings.

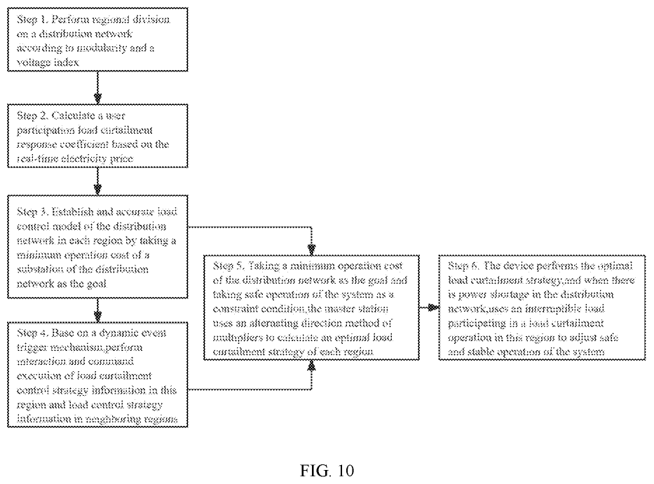

As shown in FIG. 10, the present disclosure provides a load emergency control method based on a dynamic event trigger mechanism, including the following steps:

Step 1, performing regional division on a distribution network according to a safe operation index of a system to ensure a safe operation condition of the system;

Step 2, based on the divided region, proposing an adaptive load curtailment adjustment range method based on a real-time electricity price, and establishing a user participation load curtailment response coefficient based on the real-time electricity price;

Step 3, establishing an accurate load control model of the distribution network in each region by taking a minimum operation cost of a substation of the distribution network as the goal;

Step 4, using a dynamic event trigger mechanism, achieving effective interaction and accurate execution of load curtailment strategy information in this region and load control strategy information in neighboring regions;

Step 5, according to an electricity price signal, fully considering willingness of a user side of the load curtailment in this region to participate in the load curtailment, and based on the accurate load control model of the distribution network, taking a minimum operation cost of the distribution network as the goal and taking safe operation of the system as a constraint condition, using an alternating direction method of multipliers to calculate an optimal load curtailment strategy of each region; and

Step 6, based on the optimal load curtailment strategy obtained in Step 5, when there is power shortage in the distribution network, using an interruptible load participating in a load curtailment operation in this region to adjust safe and stable operation of the system.

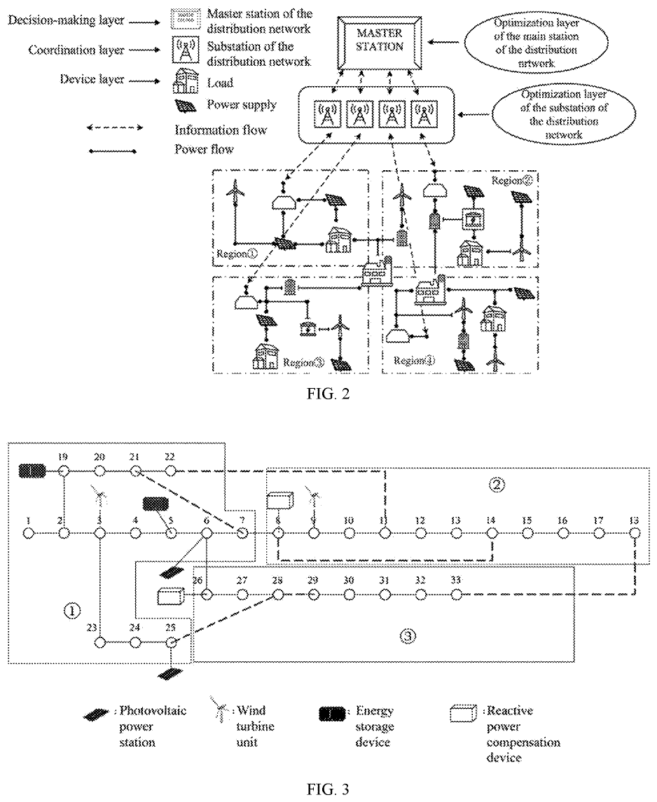

In an initial stage when the distribution network fails or power shortage occurs, there may be problems such as frequency drop, power flow violation, and tie-line power overutilization. A control system of the master station of the distribution network should be able to achieve fast and accurate load curtailment operation. A typical load curtailment control system consists of the master station in the center of the distribution network, the substation of the distribution network, and a control terminal of an electrical device, as shown in FIG. 2. The master station at a decision-making layer of the distribution network is mainly responsible for receiving the information uploaded by the control center station, performing optimal decision calculation to distribute the load curtailment, coordinating the data interaction among the substation modules of the distribution network, and issuing control operation instructions. The substation of the distribution network at a coordination layer mainly aggregates the information about the load curtailment quantity in this region, performs data interaction with the master station of the distribution network and the device layer, and executes the load curtailment control instructions issued by the master station. The terminal device layer is provided with the control terminal to collect the load curtailment quantity at the user side, uploads the load curtailment to the substation of the distribution network, and receives the instructions of the substation of the distribution network to achieve the rapid load curtailment operation.

When there is power shortage in the power grid, the division operation of the distribution network at a low accident level can solve the problems such as partial voltage and frequency violations, as well as section power exceeding the stability limit. Compared with the overall load curtailment measures, the method has the advantage of a low control cost. Therefore, the present disclosure first performs regional division on the distribution network when there is power shortage on the basis of considering stability characteristics of the power grid, that is, voltage regulation ability is fully considered on the basis of considering a modularity index to achieve optimal division of the distribution network.

The modularity index of the distribution network is used to measure a correlation degree between two nodes in a distribution network region, which is specifically as follows:

$${ρ}_{l} = \frac{1}{2 m} {\sum }_{i} {\sum }_{j} ( {l}_{ij} \frac{{k}_{i} {k}_{j}}{2 m} ) δ ( i , j ) \qquad ( 1 )$$

where Iᵢⱼ denotes an electrical distance between node i and node j, i and j denotes nodes in the distribution network, kᵢ denotes a node degree of the node i, and kᵢ=ΣᵢIᵢⱼ denotes the sum of the weights of all edges connected with the node i; m denotes the sum of weights of all edges in the region, that is,

$$m = ( {\sum }_{i} {\sum }_{j} {l}_{i j} ) / 2 ;$$

and δ(i,j) denotes a binary variable, and when δ(i,j)=1, it indicates that the nodes i and j are located in the same region, otherwise, δ(i,j)=0.

An index of the correlation degree between two nodes in the distribution network is as follows:

$${l}_{ij} = \sqrt{{\sum }_{i = 1}^{w} {( {D}_{iw} - {D}_{j w} )}^{2}} \qquad ( 2 )$$

$${D}_{ij} = lg \frac{{S}_{VP , jj} + {S}_{VQ , jj}}{{S}_{VP , jj} + {S}_{VQ , jj}} \qquad ( 3 )$$

where S_{VP} and S_{VQ} denote sensitivity matrices of an active voltage and a reactive voltage, respectively, Dᵢⱼ denotes a comprehensive influence of power change of the node j on the node i, the smaller Dᵢⱼ is, the greater the influence of power change of the node j on the node i is, and the smaller the distance between the two nodes is. The greater the value of ρₜ is, the better the division structure of the distribution network is.

In addition to considering the physical significance in terms of the structure, the regional division of the distribution network should also pay attention to the stable operation of the system. Therefore, according to the present disclosure, the voltage regulation index is introduced as an important consideration factor for regional division. The introduction of the index can effectively regulate the problem of voltage violation when there is power shortage, thereby reducing the power loss between different regions:

$${ρ}_{V} = \frac{1}{N} {\sum }_{n ∈ N} ( {\sum }_{t} {φ}_{V}^{n , t} ) . \qquad ( 4 )$$

The index is expressed by an average value of voltage deviations in each region, where

$${φ}_{v}^{n , t}$$

denotes a voltage measurement index of each node i in the region n. When a maximum value of voltage deviations ΔVᵢ in the region is less than a maximum value of allowable deviations ΔV_{i,max} in the region,

$${φ}_{v}^{n , t} = 1 ,$$

otherwise the value is ΔVᵢ/ΔV_{i,max}, and N denotes the number of divided regions.

Based on the time-of-use electricity price, the user is guided to participate in the load curtailment operation, and an adaptive load curtailment strategy based on the user response coefficient is established. The user response coefficient reflects user participation, and the user income reflects the compensation of the load curtailment to the user.

Assuming that a user expected value of the electricity price at time tis p_{ex,t}, when an actual electricity price is higher than the user expected value, user participation is high, and an adjustable load quantity increases at this time; and on the contrary, user willingness decreases, a corresponding load curtailment decreases, and therefore, a user response coefficient is established:

$${ρ}_{i , t} = {ξ}_{i} ( {e}^{\frac{{p}_{t}}{{p}_{max}} - 1} - {e}^{\frac{{p}_{ex , t}}{{p}_{max}} - 1} ) \qquad ( 5 )$$

where ρ_{i,t} denotes a response coefficient of a user at the node i participating in the distribution network at time t, pₜ denotes an actual electricity price at time t, pₘₐₓ denotes a maximum value of the electricity price, and ξᵢ denotes participation willingness of the user at the node i, ξᵢ≥0; when ρ_{i,t}>0, the user at the node i actively participates at time t, an upward margin of the load curtailment at the node increases, and a corresponding interruptible power adjustment range increases accordingly; on the contrary, a downward margin of the load curtailment decreases, and the interruptible power adjustment range decreases accordingly; and therefore, a change value reflecting the load curtailment is defined as:

$${Δ P}_{l , i , t}^{curt} = {ρ}_{i , t} ( {P}_{l , i , t}^{ori , max} - {P}_{l , i , t}^{ori , min} ) \qquad ( 6 )$$

from the previous analysis, it can be seen that when

$${Δ P}_{l , i , t}^{curt} > 0 ,$$

the user actively participates, and when

$${Δ P}_{l , i , t}^{curt} < 0 ,$$

the electricity price is lower than the user expected value, and the user participation decreases accordingly; and therefore, an upper limit and a lower limit of the load curtailment are adjusted adaptively through the electricity price signal based on original values, that is, when

$${Δ P}_{l , i , t}^{curt} \geq 0 :$$

$${P}_{l , i , t}^{up} = min ( {Δ P}_{l , i , t}^{curt} + {P}_{l , i , t}^{ori , max} , {P}_{l , i , t}^{ori , max} , {P}_{l , i , t} ) , and when \qquad ( 7 )$$

$${Δ P}_{l , i , t}^{curt} < 0 :$$

$${P}_{l , i , t}^{down} = max ( {P}_{l , i , t}^{ori , min} - {Δ P}_{l , i , t}^{curt} , {P}_{l , i , t}^{ori , min} ) ; \qquad ( 8 )$$

however, the modified upper limit of the load curtailment does not exceed a total load value of the current user, where

$${P}_{l , i , t}^{ori , max} and {P}_{l , i , t}^{ori , min}$$

denote original upper and lower limits of a load curtailment power, and

$${P}_{l , i , t}^{up} and {P}_{l , i , t}^{down}$$

denote changed upper and lower limits of the user load curtailment quantity under the guidance of the electricity price. With the change of the electricity price, the load curtailment quantity is adjusted adaptively, thereby increasing flexibility of the load curtailment.

According to the present disclosure, a load curtailment function is achieved through the operation of the interruptible load. The income obtained by the user participating in the load curtailment is related to the interruptible load quantity and the load level. The higher the interruptible load level is, the higher the compensation price of the distribution network to the user is. From the perspective of the cost of the distribution network, the cost corresponding to this compensation should be as low as possible. A cost paid by the distribution network to the user is modeled as follows:

$$min {C}_{t}^{user} = {\sum }_{m = 1}^{M} ( {λ}_{m} {P}_{m , t}^{curt} ) \qquad ( 9 )$$

where M denotes the number of interruptible load levels, and λₘ denotes a compensation price corresponding to an m-th interruptible load; in the model of the method, if the load level is higher, the compensation that the user obtains is greater, that is, the value of the compensation price λₘ corresponding to a high load level is greater; and

$${P}_{m , t}^{curt}$$

denotes a total quantity of the m-th interruptible loads at time t.

In addition, the interruptible load should also meet constraints on a safety range of the load curtailment, the number of curtailing operations, and the curtailing duration:

$${b}_{i , t} {P}_{l , i , t}^{down} \leq {P}_{l , i , t}^{curt} \leq {b}_{i , t} {P}_{l , i , t}^{up} , {b}_{i , t} ∈ [ 0 , 1 ] , and \qquad ( 10 )$$

$${P}_{l , i , t}^{curt} = {\sum }_{m = 1}^{M} {P}_{m , i , t}^{curt} . \qquad ( 11 )$$

A constraint on the maximum number of curtailing operations is:

$${\sum }_{t = 1}^{T} {b}_{i , t} , {b}_{i , t}^{max} . \qquad ( 12 )$$

Constraints on the minimum duration and the maximum duration of the load curtailment are:

$$\{ \begin{matrix}{\sum }_{t = 1}^{t + {T}_{m ax}^{curt} - 1} {b}_{i , t} \geq {T}_{m i n}^{curt} ( {b}_{i , t} - {b}_{i , t = 1} ) \\ {\sum }_{t = 1}^{t + {T}_{m ax}^{curt} - 1} ( 1 - {b}_{i , t} ) \geq 1\end{matrix} \qquad ( 13 )$$

where b_{i,t} denotes the state of the interruptible load, and when b_{i,t}=1, it indicates that the interruptible load participates in the load curtailment operation, otherwise the interruptible load does not participate in the load curtailment operation;

$${b}_{i}^{m ax}$$

denotes the maximum number of interruptions of the interruptible load; and

$${T}_{ma x}^{curt} and {T}_{m i n}^{curt}$$

denote the maximum interruption duration and the minimum interruption duration of the interruptible load.

Load curtailment control is performed on the distribution network, and an objective function is established. For the master station of the distribution network, in addition to paying compensation fees to the load curtailment of the user, it is also necessary to consider the transaction cost with the main power grid:

$$f = min {{\sum }_{i = 1}}^{I} {\sum }_{t = 1}^{T} ( {C}_{i , t}^{grid} {P}_{i , t}^{grid} + {C}_{t}^{user} ) \qquad ( 14 )$$

where

$${P}_{i , t}^{grid}$$

denotes a power value of the node i trading with the main power grid at time t, and the value is positive when electricity is purchased from the main power grid and is negative when electricity is not purchased from the main power grid; and

$${C}_{i , t}^{grid}$$

denotes a cost coefficient of the node i trading with the main power grid at time t.

In order to ensure the safe and stable operation of the distribution network, the present disclosure uses the optimal power flow of Distflow to model the constraint conditions, and uses the second-order cone programming method to relax the quadratic nonlinear shape conditions in the Distflow model, thereby transforming the original problem into a mixed integer second-order cone programming problem.

A linear power flow constraint is:

$$\{ \begin{matrix}{P}_{i , t}^{grid} + {P}_{i , t}^{DG} + {P}_{i , t}^{S} - {P}_{i , t}^{Load} - {P}_{l , i , t}^{curt} = {P}_{i , t} \\ {Q}_{i , t}^{grid} + {Q}_{i , t}^{DG} + {Q}_{i , t}^{S} - {Q}_{i , t}^{L o a d} - {Q}_{l , i , t}^{curt} = {Q}_{i , t}\end{matrix} \qquad ( 15 )$$

where

$${P}_{i , t}^{DS} and {P}_{i , t}^{S}$$

denote the active power of renewable energy outputting and energy storage charging and discharging at the node i at time t, respectively, and

$${Q}_{i , t}^{DS} and {Q}_{i , t}^{S}$$

denote the corresponding reactive power.

Phase angle relaxation of branch power flow is performed in Formula (15), and the linear power flow constraint obtained after relaxation is as follows:

$$\{ \begin{matrix}{P}_{j} = {\sum }_{k ; j \to k} {P}_{j k} - {\sum }_{i i \to j} ( {P}_{ij} - {r}_{ij} {h}_{ij} ) , ∀ j ∈ N , ∀ t \\ {Q}_{j} = {\sum }_{k ; j \to k} {Q}_{jk} - {\sum }_{i i \to j} ( {Q}_{ij} - {x}_{ij} {h}_{ij} ) , ∀ j ∈ N , ∀ t\end{matrix} . \qquad ( 16 )$$

An expression of the power at the head of the branch after relaxation is as follows:

$${P}_{ij}^{2} + {Q}_{ij}^{2} \leq {h}_{ij} {v}_{i} , ∀ t . \qquad ( 17 )$$

Formula (17) is further rewritten as a form of rotated second-order cone programming as follows:

$${‖ \begin{matrix}2 {P}_{ij} \\ 2 {Q}_{ij} \\ {h}_{ij} - {v}_{i}\end{matrix} ‖}_{2} \leq {h}_{ij} + {v}_{i} , ∀ t . \qquad ( 18 )$$

In order to ensure that the active power of a controllable unit in the distribution network operates within the allowable safety range, upper and lower operating limits are constrained as shown in Formula (19):

$${P}_{x , m i n} \leq {P}_{x} \leq {P}_{x , max} , ∀ t . \qquad ( 19 )$$

Similarly, in order to ensure that the reactive power of the controllable unit in the distribution network operates within the allowable safety range, the upper and lower operating limits are constrained as shown in Formula (20):

$${Q}_{x , min} \leq {Q}_{x} \leq {Q}_{x , m ax} , ∀ t . \qquad ( 20 )$$

During the operation of the distribution network, a voltage of each node operates within the safety range, and therefore, a constraint condition of each node is as shown in Formula (21):

$${V}_{i , m i n} \leq {V}_{i} \leq {V}_{i , m ax} , ∀ t . \qquad ( 21 )$$

The objective function and the constraint condition of the power grid load curtailment model established by the present disclosure all meet the form of a second-order cone programming problem. The decision variable is the switching state of each load in the substation, which can be effectively solved by using a commercial solver such as C Programming Language for Expressions (CPLEX).

When the power shortage occurs in the distribution network to perform the load curtailment operation, it is necessary to transmit the system operation data collected by the measuring device to the substation of the distribution network through the communication network and quickly calculate the exact load curtailment quantity. According to the user willingness to participate in the load curtailment, the interruptible load participating in the load curtailment operation in this region is used to adjust the safe and stable operation of the system.

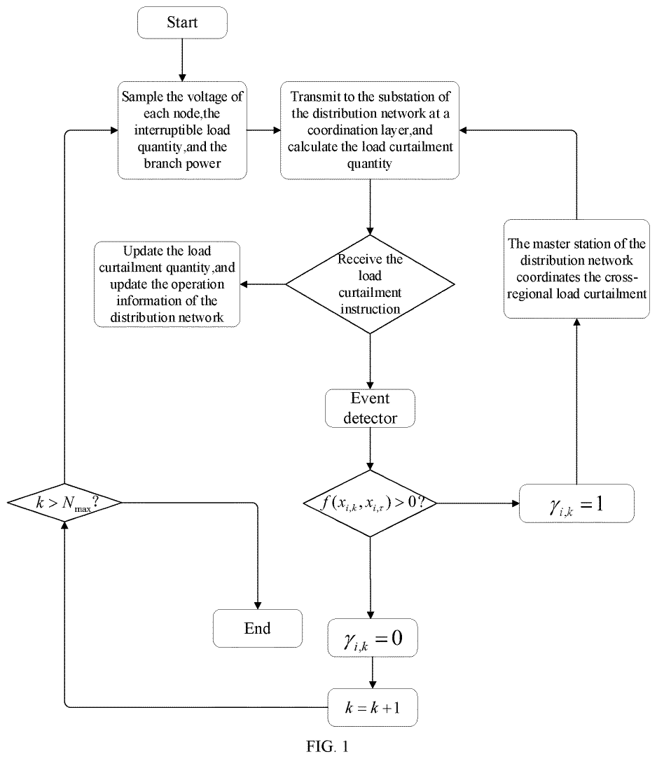

When this region has not been restored to the safe operation range of the system, the substation needs to send demand information to the master station of the distribution network, and the master station of the distribution network selects the neighboring regions that meet the conditions according to the load margin to perform the cross-regional load curtailment. In order to achieve the load curtailment operation, it is necessary to transmit information between the master station and the substation frequently. A conventional mechanism usually uses fixed-period sampling. With the wide application of a smart meter, the amount of measurement data transmitted by the network is increasing, and the pressure on the communication channel may be increased during transmission under the communication condition with a limited bandwidth, thereby leading to the network-induced phenomenon. In order to make rational use of limited communication resources and alleviate the network communication pressure, the present disclosure uses a dynamic event trigger mechanism. As shown in FIG. 1, the event is defined as whether neighboring sub-regions participate in the load curtailment operation. An event trigger detector of the substation of the distribution network may act only when receiving a trigger signal that meets the conditions, and then an event trigger controller may transmit data information to the neighboring substations. By setting a reasonable trigger function to reflect the state that the event is triggered, the data transmission amount of the master station of the distribution network in the load curtailment operation is reduced, and the communication pressure between the master station and the substation of the distribution network is alleviated.

Assuming that an operation state value of the distribution network measured by an i-th measuring device at the k-th sampling time is x_{i,k}=[P_{load,t}, P_{ij,t}, v_{i,t}]^{T}, an event generation function can be expressed as:

$${l}_{i} ( {x}_{i , k} , {x}_{i , τ} ) = ‖ {x}_{i , k} - {x}_{i , τ} ‖ - {σ}_{i} ‖ {x}_{i , τ} ‖ \qquad ( 22 )$$

where x_{i,t} denotes a system operation state vector transmitted to a master station of the distribution network at the latest time. Because the dynamic trigger event adds internal dynamic variables on the basis of the static trigger event, the communication frequency between the master station and the substation of the system can be reduced. Based on this, a generation function based on the dynamic event trigger mechanism is constructed as:

$$f ( {x}_{i , k} , {x}_{i , τ} ) = α l ( {x}_{i , k} , {x}_{i , k} ) - {δ}_{i , k} \qquad ( 23 )$$

where δ_{i,k} denotes a dynamic variable set in the dynamic event trigger mechanism, and it is proved mathematically that the minimum sampling interval under the dynamic event trigger mechanism is not less than the minimum sampling interval under a static event trigger mechanism, so that unnecessary transmission can be further reduced in the information interaction process, and δ_{i,k+1}=λδ_{i,k}−Iᵢ(x_{i,k}, x_{i,t}) here, where λ is a scalar between (0, 1), and α≥1/λ.

Between intervals (t_{i,k}, t_{i,k+1}) of any two trigger moments, a logical trigger variable γ_{i,k} is defined according to a calculated value of the event generation function, and the value of γ_{i,k} determines whether the state information of the substation is transmitted to the neighboring substation of the distribution network through the communication network, where the specific expression of the measured event logical trigger variable is:

$${γ}_{i , k} = \{ \begin{matrix}1 & f ( {x}_{i , k} , {x}_{i , τ} ) > 0 \\ 0 & f ( {x}_{i , k} , {x}_{i , τ} ) , 0\end{matrix} . \qquad ( 24 )$$

It can be seen that when γ_{i,k} is 1, the substation updates its own controller, the master station transmits the state data of the substation to a neighboring substation of the distribution network at the same time, Iᵢ(x_{i,k}, x_{i,t}) is set to 0, the trigger function is ƒ( )<0, the logic variable γ_{i,k} is set to 0 at this time and is executed again until the next trigger function is met again, and when there is power shortage and other substations need to coordinate the load curtailment to ensure the stable operation of the system, the dynamic event trigger mechanism is implemented.

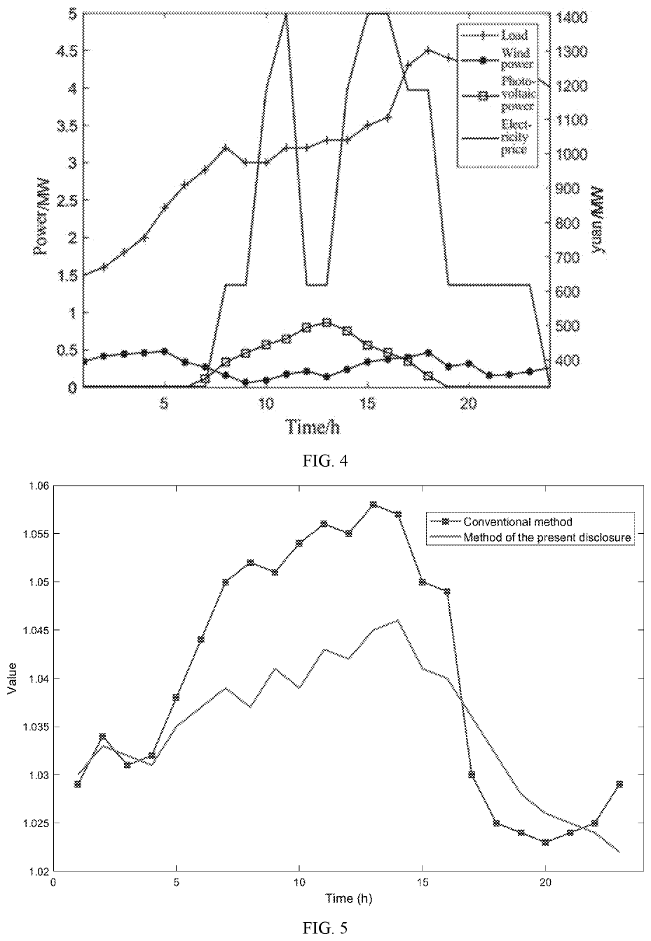

In order to verify effectiveness of the load curtailment method provided by the present disclosure, the effectiveness is verified in an improved IEEE33-node distribution network model, as shown in FIG. 3. The node numbers are 1 to 33. The divided regions are \textcircled{1}, \textcircled{2} and \textcircled{3}. The reference capacity of the system of the distribution network is 10 MVA. The reference voltage is 12.66 kV. The allowable range of per-unit value of the voltage of each node is 0.95-1.05 (p.u.). Information such as a wind turbine, a photovoltaic power, a load, and an electricity price is shown in FIG. 4.

In the simulation verification of the present disclosure, it is assumed that there is power shortage of 11 MW at the node 12 when the system is operating. According to the division method provided by the present disclosure, the improved IEEE33-node distribution network is divided into three regions as shown in different colors in FIG. 3.

In this system, nodes 6, 14 and 24 are connected to a first-level load curtailment, nodes 20, 23 and 25-28 are connected to a second-level interruptible load, and nodes 8 to 10 are connected to a third-level interruptible load. If the load is curtailed only according to the importance of the load, it is obvious that the load at nodes 6, 14 and 24 is curtailed first, thereby resulting voltage violation of nodes in some time periods. For the voltage change curve at node 6 as shown in FIG. 5, due to the photovoltaic access at the node 6 at the same time, the voltage exceeds the upper limit at 11:00-13:00 and 15:00, thereby causing some of the distributed power supply to trip and disconnect from the power grid. Because the method provided by the present disclosure fully considers the voltage index of the region and compensates for different types of load curtailments according to the importance of the loads, the load is curtailed in a decentralized manner when there is power shortage. Although some of the second-level and third-level loads are curtailed in this process, it can be ensured that the voltage of the nodes where the distributed power supply is located does not exceed the limit, and the hidden danger of large-scale power failure can be effectively avoided.

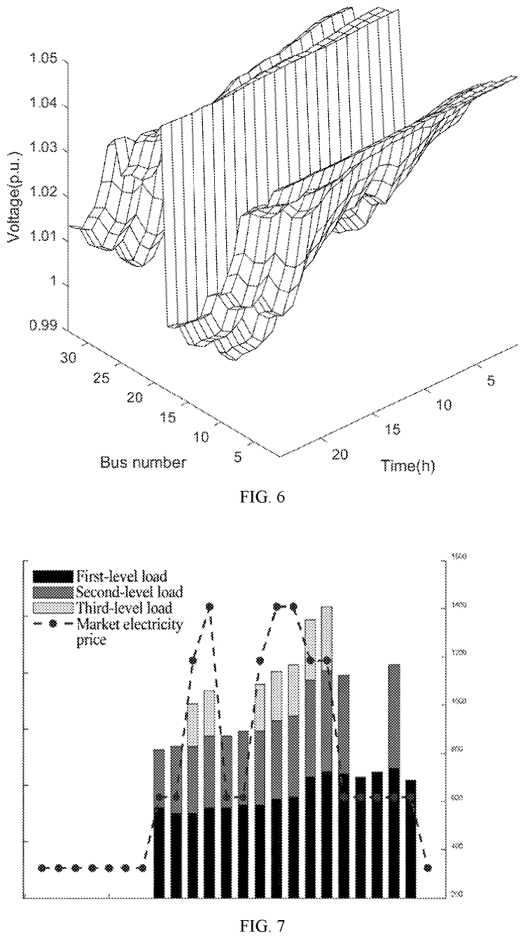

The voltage level of 33 nodes under the solution of the divided load curtailment provided by the present disclosure is shown in FIG. 6. All node voltages are within the safety range of 0.95-1.05 (p.u.), thereby meeting the voltage operation constraint of the distribution network after the load curtailment. Compared with the conventional solution according to the importance of the loads, the solution of the divided load curtailment provided by the present disclosure can ensure reliability of power supply for the user in the process of performing the load curtailment operation of the distribution network.

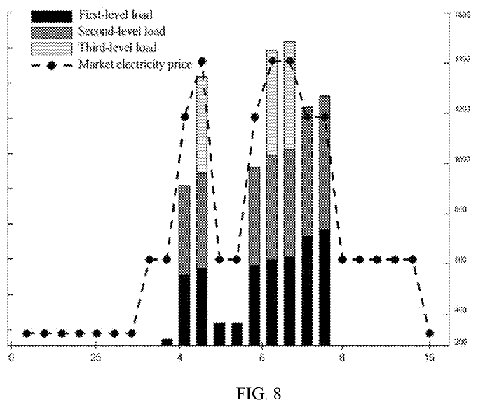

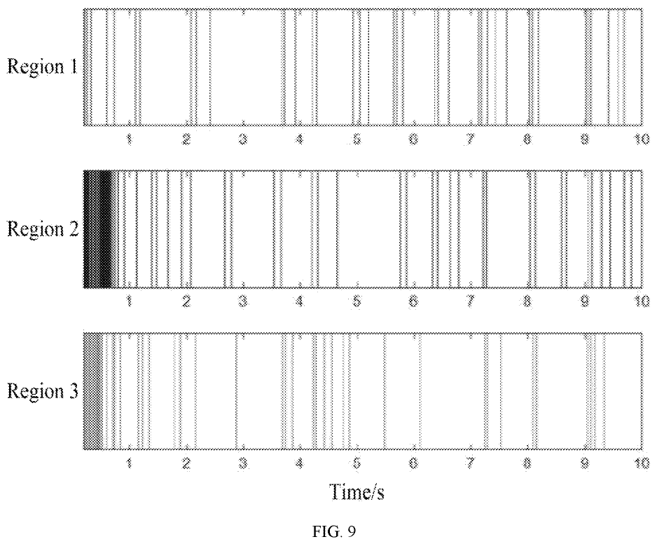

In order to verify correctness and effectiveness of the method provided by the present disclosure, under the same test environment and parameter setting, the method provided by the present disclosure is compared with the conventional method for performing the load curtailment operation according to the proportion, and results are shown in FIG. 7 and FIG. 8. At the same time, the load curtailment described in the present disclosure is divided into three levels. The higher the level is, the greater the importance of the load is. As can be seen from FIG. 7 and FIG. 8, when the power shortage occurs in the system and it is necessary to perform the load curtailment at the user side, the number of the load curtailment operations performed by the method used by the present disclosure is significantly reduced. At the same time, the number of operations of curtailing important loads performed by the method used by the present disclosure is significantly less than that by the conventional method.

In the simulation verification, the user expected value of the electricity price is set to 467 yuan/MWh in the present disclosure. This value is between the maximum value and the minimum value of the electricity price of the power grid, which is reasonable. As can be seen from FIG. 8, during the period (8:00-23:00) when the actual electricity price is higher than the user psychological price, the time for the user to really participate in the load curtailment operation is mainly concentrated in (10:00-11:00, 14:00-18:00). As can be seen from FIG. 8, the electricity price in these periods is far higher than the user psychological expected price. Therefore, the user enthusiasm for participating in the load curtailment is significantly higher than in other periods. This also shows that under the current time-of-use electricity price, the method provided by the present disclosure can guide the user to actively participate in the load curtailment operation of the distribution network. According to different electricity prices, the change range of the interruptible load can be adjusted independently, and the adaptive curtailment quantity of the interruptible load can be achieved.

As the user actively participates in the load curtailment operation during the peak period of the electricity price, if the load level is higher, the compensation that the user obtains is greater. Compared with the conventional method, the method provided by the present disclosure enables the user to obtain more compensation. The compensation amounts corresponding to the first-level load, the second-level load, and the third-level load are 350, 500, and 1000 (unit: yuan/MW), respectively. It can be seen from FIG. 8 that the quantities of the three-level loads released by the user at 11:00, 15:00 and 16:00 during the peak period of the electricity price are 0.544 MWh, 0.595 MWh, and 0.612 MWh, which are much larger than the important loads released by the conventional method in these three periods. The quantities of the three-level loads curtailed by the conventional method during the peak period of the electricity price are 0.16 MWh, 0.175 MWh, and 0.18 MWh, respectively. Therefore, the compensation obtained by the conventional method for users to curtail the load is relatively small. At the same time, based on the adaptive mechanism provided by the present disclosure that the load curtailment can be dynamically changed according to the change of the electricity price, the operation cost of the distribution network can be allowed to be lower. Because the cost of compensating the user during the peak period of the electricity price is less than the cost of purchasing electricity from the power grid, and it indicates that the master station of the distribution network only needs to pay less to purchase the released electricity from the user, the method provided by the present disclosure is better in the face of the same environment.

When there is power shortage in the distribution network to perform the load curtailment operation, because the quantity of the load curtailment in the region where the node 12 is located cannot meet the demand, it is necessary to send signals to the substation of the distribution network in two neighboring regions, which is achieved by unified coordination of the master station of the distribution network. When the measuring device in the region where the node 12 is located uses the current information about the system operation state (the load curtailment quantity, the branch power, the node voltage value, and the like) as a trigger event to transmit information to the substation of the distribution network and neighboring substations, the data transmission rate can be significantly improved because the dynamic event trigger mechanism is used in the present disclosure to achieve information transmission between neighboring regions. Here, the effects of the method provided by the present disclosure and the static event trigger mechanism in the load curtailment process are compared. Under the same test environment and parameter setting, the simulation time of two trigger mechanisms (dynamic event trigger and static event trigger) is 10 s, the parameter λ is set to 0.6, α is set to 1.5, and the trigger threshold σ is set to 0.01. The number of trigger operations under the two mechanisms are shown in Table 1. It can be seen that the number of trigger operations of the event by using the method provided by the present disclosure is obviously reduced. Compared with the static trigger event, the minimum number of trigger operations of the present disclosure can be reduced by about 25%, and the maximum number of trigger operations can be reduced by about 46%.

TABLE 1
Comparison of number of trigger operations
in different trigger methods in all regions

| region | Number of trigger operations | Number of trigger operations |
|---|---|---|
| number | of the static event | of the dynamic event |
| 1 | 89 | 54 |
| 2 | 123 | 92 |
| 3 | 116 | 62 |

FIG. 9 shows trigger moments of the measuring device in three regions under the dynamic event trigger mechanism. In the given simulation time, due to the introduction of dynamic disturbance δ, the interval between two trigger moments becomes larger, the maximum communication time interval of neighboring sub-regions is 1.3 s, 1.09 s, and 1.1 s, and the minimum communication time interval of each sub-region is greater than 0.05 s. At the same time, it can be seen from FIG. 9 that there is power shortage in region \textcircled{2}, thereby requiring that the coordinated load curtailment of the substation in other two regions achieves stability of the system. The number of trigger operations of the region \textcircled{2} are obviously more than the number of trigger operations of the other two regions. At the same time, it can be seen from FIG. 8 that the dynamic event trigger mechanism used by the present disclosure has a longer average communication time interval, which may occupy fewer communication resources to a certain extent. It can be seen that the dynamic event trigger mechanism used by the present disclosure can greatly reduce the communication frequency of the load curtailment information interaction among the sub-regions of the distribution network, which is beneficial to reducing the data transmission pressure of the communication network to a certain extent, thereby improving efficiency of the load curtailment process.

Aim at shortcomings of a conventional load curtailment solution, the present disclosure provides a load emergency control strategy based on a dynamic event trigger mechanism. Under a current dynamic electricity price mechanism, a user is guided to actively participate in the load curtailment operation of the distribution network by establishing a response coefficient. The mechanism not only helps to generate an adaptive load curtailment strategy, but also enables the user to obtain more compensation and reduces an operation cost of the master station of the distribution network. The present disclosure also improves information transmission efficiency between the master station and the substation of the distribution network by introducing a dynamic event trigger mechanism, thereby effectively reducing the communication burden in a power information transmission process.

The above is only the preferred solution of the present disclosure, and is not taken as a further limitation of the present disclosure. All equivalent changes made by using the content of the specification and the drawings of the present disclosure are within the scope of protection of the present disclosure.

What is claimed is:

1. A load emergency control method based on a dynamic event trigger mechanism, comprising the following steps:
Step 1, performing regional division on a distribution network according to a safe operation index of a system;
Step 2, based on the divided region, proposing an adaptive load curtailment adjustment range method based on a real-time electricity price, and establishing a user participation load curtailment response coefficient based on the real-time electricity price, which is specifically as follows:
assuming that a user expected value of the electricity price at time t is p_{ex,t}, when an actual electricity price is higher than the user expected value, user participation is high, and an adjustable load quantity increases at this time; and on the contrary, user willingness decreases, a corresponding load curtailment decreases, and therefore, a user response coefficient is established:
$${ρ}_{i , t} = {ξ}_{i} ( {e}^{\frac{{p}_{t}}{{p}_{max}} - 1} - {e}^{\frac{{p}_{ex , t}}{{p}_{ma x}} - 1} ) \qquad ( 5 )$$
wherein ρ_{i,t} denotes a response coefficient of a user at the node i participating in the distribution network at time t, pₜ denotes an actual electricity price at time t, pₘₐₓ denotes a maximum value of the electricity price, and ξᵢ denotes participation willingness of the user at the node i, ξᵢ≥0;
when ρ_{i,t}>0, the user at the node i actively participates at time t, an upward margin of the load curtailment at the node increases, and a corresponding interruptible power adjustment range increases accordingly; on the contrary, a downward margin of the load curtailment decreases, and the interruptible power adjustment range decreases accordingly; and therefore, a change value
$$Δ {P}_{l , i , t}^{curt}$$
reflecting the load curtailment is defined as:
$$Δ {P}_{l , i , t}^{cut} = {ρ}_{i , t} ( {P}_{l , i , t}^{ori , max} - {P}_{l , i , t}^{ori , min} ) \qquad ( 6 )$$
when
$$Δ {P}_{l , i , t}^{curt} > 0 ,$$
the user actively participates, and when
$$Δ {P}_{l , i , t}^{curt} < 0 ,$$
the electricity price is lower than the user expected value, and the user participation decreases accordingly; and therefore, an upper limit and a lower limit of the load curtailment are adjusted adaptively through the electricity price signal based on original values, that is:
$$when Δ {P}_{l , i , t}^{curt} \geq 0 : {P}_{l , i , t}^{up} = min ( Δ {P}_{l , i , t}^{curt} + {P}_{l , i , t}^{ori , max} , {P}_{l , i , t}^{ori , max} {P}_{l , i , t} ) , \qquad ( 7 )$$
$$and$$
$$when Δ {P}_{l , i , t}^{curt} < 0 : {P}_{l , i , t}^{down} = max ( {P}_{l , i , t}^{ori , m i n} - Δ {P}_{l , i , t}^{curt} , {P}_{l , i , t}^{ori , m i n} ) \qquad ( 8 )$$
the adjusted upper limit of the load curtailment does not exceed a total load value of the current user,
wherein
$${P}_{l , i , t}^{ori , max} and {P}_{l , i , t}^{ori , m i n}$$
denote original upper and lower limits of a load curtailment power, and
$${P}_{l , i , t}^{up} and {P}_{l , i , t}^{down}$$
denote changed upper and lower limits of the user load curtailment quantity under the guidance of the electricity price;
Step 3, establishing an accurate load control model of the distribution network in each region by taking a minimum operation cost of a substation of the distribution network as the goal, which is specifically as follows:
performing load curtailment control on the distribution network and establishing an objective function:
$$f = min {{\sum }_{i = 1}}^{I} {\sum }_{t = 1}^{T} ( {C}_{i , t}^{grid} {P}_{i , t}^{grid} + {C}_{t}^{user} ) \qquad ( 14 )$$
wherein
$${P}_{i , t}^{grid}$$
denotes a power value of the node i trading with the main power grid at time t, and the value is positive when electricity is purchased from the main power grid and is negative when electricity is not purchased from the main power grid;
$${C}_{i , t}^{grid}$$
denotes a cost coefficient of the node i trading with the main power grid at time t; and Cₜ^{user} denotes a cost generated by the distribution network to compensate the user at time t,
in order to ensure safe operation of the system, it is necessary to establish a constraint condition for the safe operation, wherein a linear power flow constraint is:
$$\{ \begin{matrix}{P}_{i , t}^{grid} + {P}_{i , t}^{DG} + {P}_{i , t}^{S} - {P}_{i , t}^{Load} - {P}_{l , i , t}^{curt} = {P}_{i , t} \\ {Q}_{i , t}^{grid} + {Q}_{i , t}^{DG} + {Q}_{i , t}^{S} - {Q}_{i , t}^{Load} - {Q}_{l , i , t}^{curt} = {Q}_{i , t}\end{matrix} \qquad ( 15 )$$
wherein
$${P}_{i , t}^{DS} and {P}_{i , t}^{S}$$
denote the active power of renewable energy outputting and energy storage charging and discharging at the node i at time t, respectively, and
$${Q}_{i , t}^{DS} and {Q}_{i , t}^{S}$$
denote the corresponding reactive power; and
$${P}_{l , i , t}^{cut}$$
denotes a total quantity of all interruptible loads at the node i at time t;
phase angle relaxation of branch power flow is performed in Formula (15), and the linear power flow constraint obtained after relaxation is as follows:
$$\{ \begin{matrix}{P}_{j} = {\sum }_{k ; j \to k} {P}_{jk} - {\sum }_{ii \to j} ( {P}_{ij} - {r}_{ij} {h}_{ij} ) , & ∀ j ∈ N , ∀ t \\ {Q}_{j} = {\sum }_{k ; j \to k} {Q}_{jk} - {\sum }_{ii \to j} ( {Q}_{ij} - {x}_{ij} {h}_{ij} ) , & ∀ j ∈ N , ∀ t\end{matrix} \qquad ( 16 )$$
an expression of the power at the head of the branch after relaxation is as follows:
$${P}_{ij}^{2} + {Q}_{ij}^{2} \leq {h}_{ij} {v}_{i} , ∀ t \qquad ( 17 )$$
Formula (17) is further rewritten as a form of rotated second-order cone programming as follows:
$${‖ \begin{matrix}2 {P}_{ij} \\ 2 {Q}_{ij} \\ {h}_{ij} - {v}_{i}\end{matrix} ‖}_{2} \leq {h}_{ij} + {v}_{i} , ∀ t \qquad ( 18 )$$
in order to ensure that the active power of a controllable unit in the distribution network operates within the allowable safety range, upper and lower operating limits are constrained as shown in Formula (19):
$${P}_{x , min} \leq {P}_{x} \leq {P}_{x , max} , ∀ t \qquad ( 19 )$$
similarly, in order to ensure that the reactive power of the controllable unit in the distribution network operates within the allowable safety range, the upper and lower operating limits are constrained as shown in Formula (20):
$${Q}_{x , min} \leq {Q}_{x} \leq {Q}_{x , max} , ∀ t \qquad ( 20 )$$
during the operation of the distribution network, a voltage of each node operates within the safety range, and therefore, a constraint condition of each node is as shown in Formula (21):
$${V}_{i , min} \leq {V}_{i} \leq {V}_{i , max} , ∀ t ; \qquad ( 21 )$$
Step 4, based on a dynamic event trigger mechanism, achieving effective interaction and accurate execution of load curtailment strategy information in this region and load control strategy information in neighboring regions;
Step 5, according to an electricity price signal, fully considering willingness of a user side of the load curtailment in this region to participate in the load curtailment, and based on the accurate load control model of the distribution network, taking a minimum operation cost of the distribution network as the goal and taking safe operation of the system as a constraint condition, using an alternating direction method of multipliers to calculate an optimal load curtailment strategy of each region; and
Step 6, based on the optimal load curtailment strategy obtained in Step 5, when there is power shortage in the distribution network, using an interruptible load participating in a load curtailment operation in this region to adjust safe and stable operation of the system.

2. The load emergency control method based on the dynamic event trigger mechanism according to claim 1, wherein in Step 1, regional division is performed on the distribution network on the basis of considering stability characteristics of the power grid, that is, voltage regulation ability is fully considered on the basis of considering a modularity index to achieve optimal division of the distribution network;
the modularity index of the distribution network is used to measure a correlation degree between two nodes in a distribution network region, which is specifically as follows:
$${ρ}_{l} = \frac{1}{2 m} {\sum }_{i} {\sum }_{j} ( {l}_{ij} - \frac{{k}_{i} {k}_{j}}{2 m} ) δ ( i , j ) \qquad ( 1 )$$
wherein ρᵢ denotes a correlation degree between nodes, Iᵢⱼ denotes an electrical distance between node i and node j, i and j denotes nodes in the distribution network, kᵢ denotes a node degree of the node i, and kᵢ=ΣᵢIᵢⱼ denotes the sum of the weights of all edges connected with the node i; kⱼ denotes a node degree of the node j; m denotes the sum of weights of all edges in the divided region, that is,
$$m = ( {\sum }_{i} {\sum }_{j} {l}_{ij} ) / 2 ;$$
and δ(i,j) denotes a binary variable, and when δ(i,j)=1, it indicates that the nodes i and j are located in the same region, otherwise, δ(i,j)=0;
an index of the correlation degree between two nodes in the distribution network is as follows:
$${l}_{ij} = \sqrt{{\sum }_{i = 1}^{w} {( {D}_{iw} - {D}_{jw} )}^{2}} \qquad ( 2 )$$
$${D}_{ij} = lg \frac{{S}_{VP , jj} + {S}_{VQ , jj}}{{S}_{VP , ij} + {S}_{VQ , ij}} \qquad ( 3 )$$
wherein values of i and j range from 1 to w, i≠j; S_{VP,jj} denotes voltage sensitivity of a load node j to active power supply j, S_{VQ,jj} denotes voltage sensitivity of the load node j to reactive power supply j, S_{VP,ij} denote voltage sensitivity of a load node i to the active power supply j, and S_{VQ,ij} denote voltage sensitivity of the load node i to the reactive power supply j; D_{iw} is used to measure an influence of a node w on the node i, D_{jw} is used to measure an influence of the node w on the node j, Dᵢⱼ denotes a comprehensive influence of power change of the node j on the node i, the smaller Dᵢⱼ is, the greater the influence of power change of the node j on the node i is, and the smaller the distance between the two nodes is; and the greater the value of ρᵢ is, the better the division structure of the distribution network is; and
considering the voltage regulation ability, a voltage regulation index is introduced to perform regional division, which is specifically as follows:
$${ρ}_{V} = \frac{1}{N} {\sum }_{n ∈ N} ( {\sum }_{t} {φ}_{V}^{n , t} ) \qquad ( 4 )$$
wherein ρᵥ denotes an average value of voltage deviations in each region;
$${φ}_{v}^{n , t}$$
denotes a voltage measurement index of each node i in the region n at time t; and when a maximum value of voltage deviations ΔVᵢ in the region is less than a maximum value of allowable deviations ΔV_{i,max} in the region,
$${φ}_{v}^{n , t} = 1 ,$$
otherwise the value is ΔVᵢ/ΔV_{i,max}, and N denotes the number of divided regions.

3. The load emergency control method based on the dynamic event trigger mechanism according to claim 1, wherein a cost paid by the distribution network to the user is modeled as follows:
$$min {C}_{t}^{user} = {\sum }_{m = 1}^{M} ( {λ}_{m} {P}_{m , t}^{curt} ) \qquad ( 9 )$$
wherein
$${C}_{t}^{user}$$
denotes a cost generated by the distribution network to compensate the user at time t, M denotes the number of interruptible load levels, and λₘ denotes a compensation price corresponding to an m-th interruptible load; if the load level is higher, the compensation that the user obtains is greater, that is, the value of the compensation price λₘ corresponding to a high load level is greater; and
$${P}_{m , t}^{curt}$$
denotes a total quantity of the m-th interruptible loads at time t;
a constraint of the interruptible load on a safety range of the load curtailment is:
$${b}_{i , t} {P}_{l , i , t}^{down} \leq {P}_{l , i , t}^{curt} \leq {b}_{i , t} {P}_{l , i , t}^{up} , {b}_{i , t} ∈ [ 0 , 1 ] \qquad ( 10 )$$
wherein
$${P}_{l , i , t}^{curt}$$
denotes a total quantity of all interruptible loads at the node i at time t;
$${P}_{l , i , t}^{curt} = {\sum }_{m = 1}^{M} {P}_{m , i , t}^{curt} \qquad ( 11 )$$
wherein
$${P}_{m , i , t}^{curt}$$
denotes the quantity of the m-th interruptible loads at the node i at time t;
a constraint on the maximum number of curtailing operations is:
$${\sum }_{t = 1}^{T} {b}_{i , t} , {b}_{i}^{m ax} \qquad ( 12 )$$
wherein
$${b}_{i}^{m ax}$$
denotes the maximum number of interruptions of the interruptible load; and
constraints on the minimum duration and the maximum duration of the load curtailment are:
$$\{ \begin{matrix}{\sum }_{t = 1}^{t + {T}_{m i n}^{curt} - 1} {b}_{i , t} \geq {T}_{m i n}^{curt} ( {b}_{i , t} - {b}_{i , t - 1} ) \\ {\sum }_{t = 1}^{t + {T}_{m ax}^{curt} - 1} ( 1 - {b}_{i , t} ) \geq 1\end{matrix} \qquad ( 13 )$$
wherein b_{i,t} denotes the state of the interruptible load at time t, and b_{i,t-1} denotes the state of the interruptible load at time t-1; when b_{i,t}=1, it indicates that the interruptible load participates in the load curtailment operation, otherwise the interruptible load does not participate in the load curtailment operation;
$${b}_{i}^{m ax}$$
denotes the maximum number of interruptions of the interruptible load; and
$${T}_{m ax}^{curt} and {T}_{m i n}^{curt}$$
denote the maximum interruption duration and the minimum interruption duration of the interruptible load.

4. The load emergency control method based on the dynamic event trigger mechanism according to claim 1, wherein Step 4 specifically comprises:
assuming that an operation state value of the distribution network measured by an i-th measuring device at the k-th sampling time is x_{i,k} [P_{load,t}, P_{ij,t}, v_{i,t}]^{T}, expressing an event generation function as:
$${l}_{i} ( {x}_{i , k} , {x}_{i , τ} ) = ‖ {x}_{i , k} - {x}_{i , τ} ‖ - {σ}_{i} ‖ {x}_{i , τ} ‖ \qquad ( 22 )$$
wherein x_{i,t} denotes a system operation state vector transmitted to a master station of the distribution network at the latest time; and σᵢ denotes a trigger threshold of the i-th measuring device;
based on Formula (22), constructing a generation function based on the dynamic event trigger mechanism as:
$$f ( {x}_{i , k} , {x}_{i , τ} ) = α l ( {x}_{i , k} , {x}_{i , k} ) - {δ}_{i , k} \qquad ( 23 )$$
wherein δ_{i,k} denotes a dynamic variable set in the dynamic event trigger mechanism, and the minimum sampling interval under the dynamic event trigger mechanism is not less than the minimum sampling interval under a static event trigger mechanism; and δ_{i,k+1}=λδ_{i,k}−Iᵢ(x_{i,k}, x_{i,t}), wherein λ is a scalar between (0, 1), and α≥1/λ; and
based on Formula (23), between intervals (t_{i,k}, t_{i,k+1}) of any two trigger moments, defining a logical trigger variable γ_{i,k} according to a calculated value of the event generation function, wherein the specific expression is:
$${γ}_{i , k} = \{ \begin{matrix}1 & f ( {x}_{i , k} , {x}_{i , τ} ) > 0 \\ 0 & f ( {x}_{i , k} , {x}_{i , τ} ) , 0\end{matrix} \qquad ( 24 )$$
wherein according to Formula (24), when γ_{i,k} is 1, the substation updates its own controller, the master station transmits the state data of the substation to a neighboring substation of the distribution network at the same time, Iᵢ(x_{i,k}, x_{i,t}) is set to 0, the trigger function is ƒ( )<0, the logic variable γ_{i,k} is set to 0 at this time and is executed again until the next trigger function is met again, and when there is power shortage and other substations need to coordinate the load curtailment to ensure the stable operation of the system, the dynamic event trigger mechanism is implemented.
